(19) United States
(12) Patent Application Publication
(10) Pub. No.: US 2008/0006706 A1
(43) Pub. Date: Jan. 10, 2008

(54) Card With Input Elements For Entering A Pin Code And Method Of Entering A Pin Code

(75) Inventors: Gerardus Cornelis Jorna, Waalre (NL); Peter Jan Slikkerveer, Waalre (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/722,741

(22) PCT Filed: Dec. 21, 2005
(86) PCT No.: PCT/IB05/54359

§ 371 Date: Jun. 25, 2007

(30) Foreign Application Priority Data
Jan. 4, 2005 (EP) 05100026.3

(51) Int. Cl. G06K 19/06

(52) U.S. Cl. 235/494

(57) ABSTRACT

A card (CAR), for example for storing confidential information (inf) and/or performing security actions, the card (CAR) comprising input elements (T1, T2) for entering a PIN code, wherein a specific unambiguous value is assigned to each input element (T1, T2), and wherein the card (CAR) comprises at least two and maximally nine of said input elements (T1, T2).

### FIELD OF THE INVENTION

The invention relates to a card comprising input elements for entering a PIN code.

The invention also relates to a method of entering a PIN code into a card.

The invention further relates to a card reader.

### BACKGROUND OF THE INVENTION

Cards of this type are generally used for storing information, particularly confidential information, and/or for generating information after a PIN code (“Personal Identification Number”) has been entered correctly into the card. Alternatively or additionally, such cards may also be used to perform security functions, such as generating a TAN code (“TransAction Number”). Access to the confidential information stored on the card is permitted—for at least a predetermined period of time—when the PIN code is entered correctly into the card, or when the information is generated—preferably in the card—after the PIN code has been entered correctly.

As mentioned above, a security action may also be performed, preferably by the card, after entering the correct PIN code.

However, it should be noted that the invention is not limited to the applications as described above, but refers to any (small) card into which a PIN code has to be entered directly without using an external device.

An example of cards for storing information is the so-termed “smart card”. A smart card is a card made of plastic or other suitable material which has some degree of processing capability. Typically, smart cards may be programmed to perform a wide variety of functions. For example, a single smart card may be programmed as a key for opening doors, store medical information, or serve as an electronic credit card.

Further applications of smart cards include their use as credit cards or ATM (“automatic teller machine”) cards, SIMs (“subscriber identity module”) for mobile phones, authorization cards for pay television, high security identification and access control cards, public transport tickets, etc.

Smart cards may also be used as electronic wallets. The smart card chip can be loaded with electronic money, which may be used for parking meters, vending machines, and merchants. Cryptographic protocols protect the exchange of money between the smart card and the accepting machine.

Smart cards have been advertised as being suitable for these tasks, because they are engineered to be tamper-resistant. The embedded chip of a smart card normally implements some cryptographic algorithm.

“Contact-type” smart cards are defined in the ISO/IEC 7816 series of standards. A second type is the “non-contact type”, called contactless smart card, wherein the chip communicates with the card reader through a wireless, often self-powered induction technology.

A standard for such a contactless protocol for smart cards is ISO/IEC 14443. An alternative standard for contactless smart cards is ISO 15693. There are other international standards or proprietary standards in the RFID (radio frequency identification) technology for contactless smart cards, for example, for electronic toll collection or other applications.

The smart cards described above may contain different types of data. Some of the data may be non-confidential, while other data is confidential (personal for the owner/main user of the card). The distinction is particularly important when a second person other than the main user/owner of the card handles the card, for example, funds the card when it has been lost. This second person should not be able to access the confidential information, whereas he might be allowed to access the non-confidential information.

To obtain access to the confidential data, a PIN code has to be entered correctly into the card. This is usually done by using a reader which comprises a number of keys for entering the PIN code and a display which shows the entered code or indicates the number of digits already entered, while the entered characters are masked with, for example, the character “X”.

The used PIN code usually consists of a string of four characters of decimal values, and the keypad comprises ten keys with the numerals 0 to 9. For example, the PIN code is 2415.

Furthermore, smart cards with displays are known in the state of the art. These cards may contain information intended for the owner's use only and needs to be secured from unauthorized use, such as, for example, account numbers, social security numbers, medical information, passwords to other applications (e.g. internet portals), sometimes depending on user personal data such as phone number, date of birth, etc.

Such smart cards are known from U.S. Pat. No. 6,776,332 B2. To allow the user direct access to the confidential information without using a reader, the known smart card comprises means for entering a PIN code. U.S. Pat. No. 6,776,332 B2 describes a smart card comprising a keypad with ten different keys with the numerals 0 to 9 for entering a decimal PIN code.

However, since typical smart cards are rather small, such a known embodiment has different drawbacks. It is difficult to arrange the keys on the card, particularly because also a display has to be arranged on the smart card. Moreover, the keys must be rather small, which makes the input of the PIN code difficult for a user.

It has been proposed to use only two or three buttons to input a decimal PIN code on a smart card. One or two buttons are provided to navigate through the ten numerals 0 to 9 with an up and/or down button or a right/and or left button. The numerals are shown on a display, and when the correct number is highlighted, an enter button is pressed to choose this number. This procedure is repeated four times until the correct PIN code has been entered.

Such an embodiment of a smart card has the advantage that only two buttons (a right/left/up/down button and an enter button) or only three buttons (a right and a left button or an up and a down button and an enter button) are necessary on the smart card. However, it is a major disadvantage of this embodiment that the buttons normally have to be pressed several times until the PIN code has been entered.

### OBJECT AND SUMMARY OF THE INVENTION

It is an object of the invention to provide a card of the type defined in the opening paragraph and a method of the type defined in the second paragraph and a card reader defined in the third paragraph, which allows entering a PIN code directly on a card, on which confidential data are stored, in a more convenient way.

In order to achieve the object defined above, a card according to the invention has such characteristic features that it can be characterized in the way defined below, namely:

A card comprising input elements for entering a PIN code into the card, wherein a specific unambiguous value is assigned to each input element, and wherein the card comprises at least two and maximally nine of said input elements.

In order to achieve the object defined above, a method according to the invention has such characteristic features that it can be characterized in the way defined below, namely:

A method of entering a PIN code into a card, using input elements, wherein a specific unambiguous value is assigned to each input element, and wherein at least two and maximally nine of said input elements are provided for entering the PIN code.

In order to achieve the object defined above, a card reader according to the invention has such characteristic features that it can be characterized in the way defined below, namely:

A card reader for a card, the reader being capable of carrying out a method of entering a PIN code into a card, using input elements, wherein a specific unambiguous value is assigned to each input element, and wherein at least two and maximally nine of said input elements are provided for entering the PIN code.

The characteristic features of the invention provide the advantage that it is easier to arrange a smaller number of input elements for entering a PIN code, for example, keys, on a card such as a smart card in a convenient way. Due to the smaller number of input elements, said elements may be constructed to be larger than in the case of ten buttons as known in the state of the art, so that the operation of said elements is more convenient for a user.

The invention provides the possibility of considerably reducing the number of times input elements need to be operated as compared to the second embodiment known in the state of the art and described above, because each input element has a specific, unambiguous value, e.g. in the form of a specific character such as A, B, C, . . . or 1, 2, 3, . . . , or other symbols, thereby making a card more accessible and easier to operate.

According to the invention, the number of values per character of the PIN code is the same as the number of input elements (two input elements=binary code, three input elements=ternary code), whereas there are two or three buttons for a decimal system in the case of scroll buttons, which makes the entering of the PIN code usually much more complicated and time-consuming.

The invention therefore makes optimal use of a few input elements for entering a PIN code on a card.

Until now, PIN codes for securing access to a smart card have always been based on the decimal system. The invention replaces the well-known and established decimal PIN code by an N-code, wherein 2≦N≦9.

Refraining from a decimal code also allows a larger variation of security by varying the number of characters in the “pin code”, while the risk of other people “scanning or overseeing” the code is also very low as compared with a decimal PIN code (it is much more difficult to remember a code like ACBBABA in the case of a ternary code with three input elements according to the invention than a simple number such as 2415 in a decimal PIN code).

The measures as defined in claim 2, 3, 4 or 12 provide the advantage that a very small number of input elements is used for entering the PIN code, so that input elements having a size which allows comfortable operation may be used. Furthermore, the input elements may be arranged in a favorable manner.

Particularly when only two input elements are used, the size and positions of the input elements on the card may be chosen in such a way that operation of the input elements is very comfortable.

The use of three or four input elements reduces the number of possible arrangements of the input elements on the card, and, furthermore, the size of the input elements has to be reduced when compared with the situation of only two input elements on the card. However, the operation of the input elements still remains comfortable, and, moreover, the PIN code may be shorter.

Some solutions according to the invention provide the advantage that a sufficient security of the PIN code is achieved. The security may be calculated simply by taking the number of input elements to the power of the number of characters of the PIN code.

A number of four characters for a PIN code may already be sufficient for only two input elements, particularly when a user has only one possibility of entering the correct PIN code before the card is locked. However, since it is advantageous when a user has more possibilities, usually three until the card is locked due to entering of a false PIN code, it is advantageous when the PIN code consists of at least four, five, or seven characters. In the case of two input elements, a sufficiently high security of the PIN code may be achieved by using seven characters in the PIN code, and in the case of three input elements, five characters in the PIN code are sufficient. As already mentioned above, in the case of four input elements, four characters in the PIN code may be sufficient.

However, to increase security, the number of characters in the PIN code should be increased. Furthermore, different lengths of PIN codes could be used for different applications that might run on the same card, or for different information stored, etc.

Further solutions according to the invention provide the advantage that a display supplies a user with feedback information on the number of characters of the PIN code that have been entered. The PIN code is preferably masked in the display by showing the same character such as an “X” or a “*” so that the entered PIN code cannot be spied upon by other persons.

Further solutions according to the invention provide the advantage that a display is used which is optimal for use with a card according to the invention.

Further solutions according to the invention provide the advantage that the display comprises a display cell for each character of the PIN code, wherein each display cell is capable of displaying two or more characters of the PIN code. These measures provide the possibility of significantly increasing the security of the PIN code in a simple and efficient way, because, for example, with a 7-cell display, which is capable of displaying characters of a PIN code in one cell, the PIN code may have a maximum length of fourteen characters.

### BRIEF DESCRIPTION OF THE DRAWINGS

These and other aspects of the invention are apparent from and will be elucidated with reference to the embodiments described hereinafter.

In the drawings,

FIG. 1 is a schematic illustration of a basic smart card.

FIG. 2 is a block diagram of the smart card of FIG. 1.

FIG. 3 is a more detailed schematic illustration of a first embodiment of a smart card according to the invention.

FIG. 4 is a more detailed schematic illustration of a second embodiment of a smart card according to the invention.

FIG. 5 is a more detailed schematic illustration of a third embodiment of a smart card according to the invention.

FIG. 6 shows a specific embodiment of a display to be used for a card according to the invention.

FIG. 7 shows a reader communicating with a smart card according to the invention.

### DESCRIPTION OF EMBODIMENTS

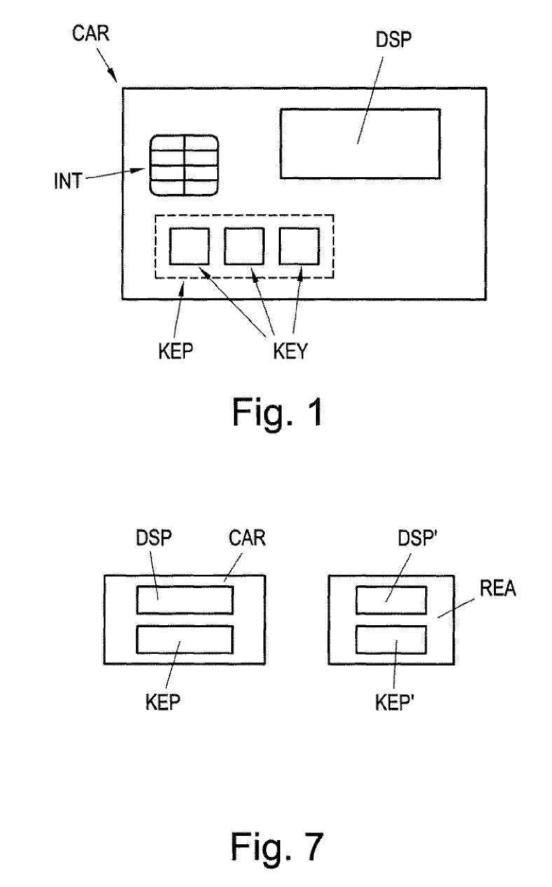

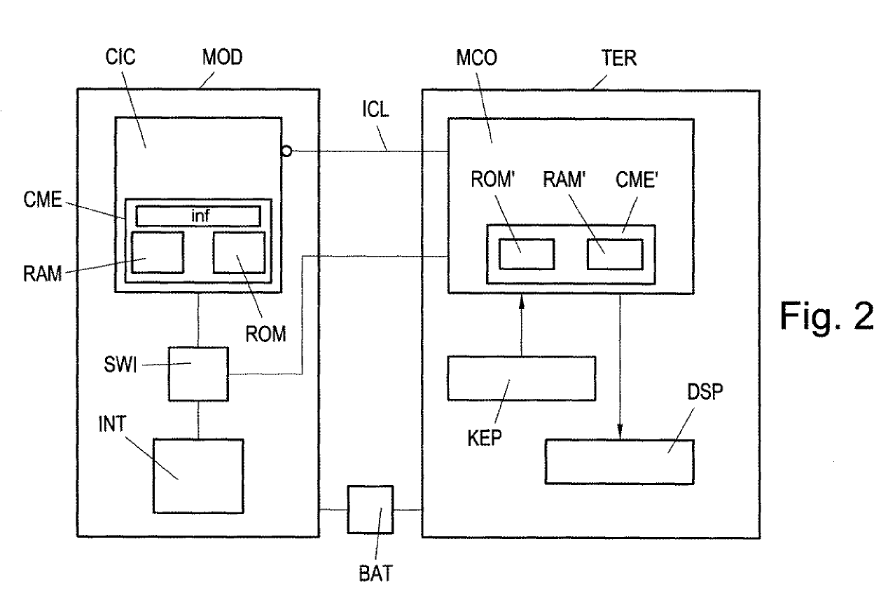

FIG. 1 shows a typical card for storing information, particularly confidential information inf. In this embodiment, the card is a smart card CAR. For example, such a smart card CAR has the physical dimensions of a typical credit card. The smart card CAR has a keypad KEP located thereon. The keypad KEP consists of input elements such as keys KEY for entering numbers or characters for entering a PIN code. The smart card CAR displays the PIN code PIN and possibly text messages and numerical results on its display DSP, for example, an LCD display. Furthermore, the smart card CAR is also provided with a power supply, such as a battery (see FIG. 2).

Additionally, the smart card CAR has an interface device, such as an electric interface plate INT, providing an electric contact point between a card reader (not shown in FIG. 1) and the circuit of the smart card CAR.

When the smart card CAR is inserted into a slot of the card reader, the electric interface plate INT is brought into electrical contact with a set of electric contacts provided in the card reader to establish a communication link between the card reader and the smart card CAR. On its front or back surface, the smart card CAR may have typical information of a transaction card, such as the card issuer institution, an embossed card account number, an embossed name of the user, and an embossed expiry date and hologram.

However, the card may also be a contactless smart card. For the purposes of the invention, it may also be assumed that the confidential information inf stored on the card CAR may only (or additionally) be accessed directly via the card CAR, the confidential information then being displayed on the display DSP, for example. In this case, an electric interface plate INT or means for communication without a contact is not (absolutely) necessary.

FIG. 2 shows components of the smart card CAR. In this non-limiting embodiment, the smart card CAR consists of two main sections: an embedded terminal TER and a card personality module MOD. Both sections are powered by a battery BAT.

The keypad KEP, the display DSP, a microcontroller MCO, and a controller memory CME′ form the embedded terminal TER. The microcontroller MCO is preferably a CPU having built-in controller functions.

Associated with the microcontroller MCO is the controller memory CME′. The controller memory CME′ may comprise a volatile memory, such as a Random Access Memory (RAM) RAM′, and a non-volatile memory, such as an Electronically Erasable Read-only Memory (EEPROM) ROM′. The software operating on the microcontroller MCO may be permanently stored in the EEPROM ROM′. The software controls the interface operation of keypad KEP and the display DSP.

The embedded terminal TER provides a local interface on the smart card CAR to enable the local entry of a PIN code PIN into the smart card CAR without having to interface to an external terminal, such as a card reader.

The card personality module MOD comprises a smart card integrated circuit (IC) CIC, which is a CPU tailored to smart card functions, and its associated memory elements. Associated with IC CIC is the memory CME, which may include a non-volatile portion, EEPROM ROM, for storing application software and smart card data, and a volatile portion RAM, for temporary storage of data.

In this embodiment, the confidential information inf as well as non-confidential information is stored in the memory CME of the card personality module MOD. The confidential information inf may comprise any information, such as data and/or one or more applications, for example, a banking or credit card application.

The confidential information inf may be stored in an encrypted form in the memory CME, or the memory CME or a part thereof is a secure memory which can only be accessed after entering the correct PIN code.

The confidential information inf, for example, the confidential data may be accessed by entering the correct PIN code and will then be displayed on the display DSP or made available to a reader, or an application stored on the smart card CAR will become visible to a reader, for example, via the interface plate INT, after entering the correct PIN code into the smart card CAR.

The integrated circuit CIC of the card personality module MOD and the microcontroller MCO communicate via an internal communication link ICL. Furthermore, the IC CIC and the microprocessor MCO are connected with the interface plate INT via a switch SWI.

In another embodiment, an antenna (not shown) on a card reader may be provided as a contactless interface with a corresponding antenna (not shown) on the smart card CAR as an interface device for the IC CIC. Such a contactless interface may provide communication between the smart card CAR and the card reader in conformity with the international standard ISO/IEC 14443.

In the embodiment, an enable switch SWI is disposed between the IC CIC and the electric interface plate INT. The microcontroller MCO controls the operation of the enable switch SWI and consequently the electrical connection between the IC CIC and the electric interface plate INT. When a user enters the correct PIN code via the key pad KEP, the microcontroller MCO engages the switch SWI to allow the IC CIC to communicate with an external device and to present the confidential information inf, for example, an application, via the electric interface plate INT. Until the switch SWI is engaged, no signal may be transmitted from IC CIC to the electric interface plate INT, and the confidential information inf, such as data or applications, stays confidential. The communication between the IC CIC and a card reader via the electric interface plate INT may be established only when the enable switch SWI is engaged by the microcontroller CIC.

The above description of a smart card CAR has only been given as a basic explanation of the function of a preferred embodiment of a smart card CAR in connection with the invention which will be described hereinafter. However, it is not necessary for the invention that the smart card CAR internally consists of two separate modules MOD, TER. In principle, the functions of these two modules MOD, TER may also be managed only by the IC CIC, thus rendering the terminal TER superfluous.

In the intended use of a smart card CAR, the card memory contains confidential information/data that can be accessed by the user of the card without any additional equipment. The smart card CAR will contain the data, the processor and the user interface to access the data.

The (confidential) information inf is entered into the card by means of, for example, a card-representative/machine or by the holder of the smart card CAR through the Internet site of the card company, etc.

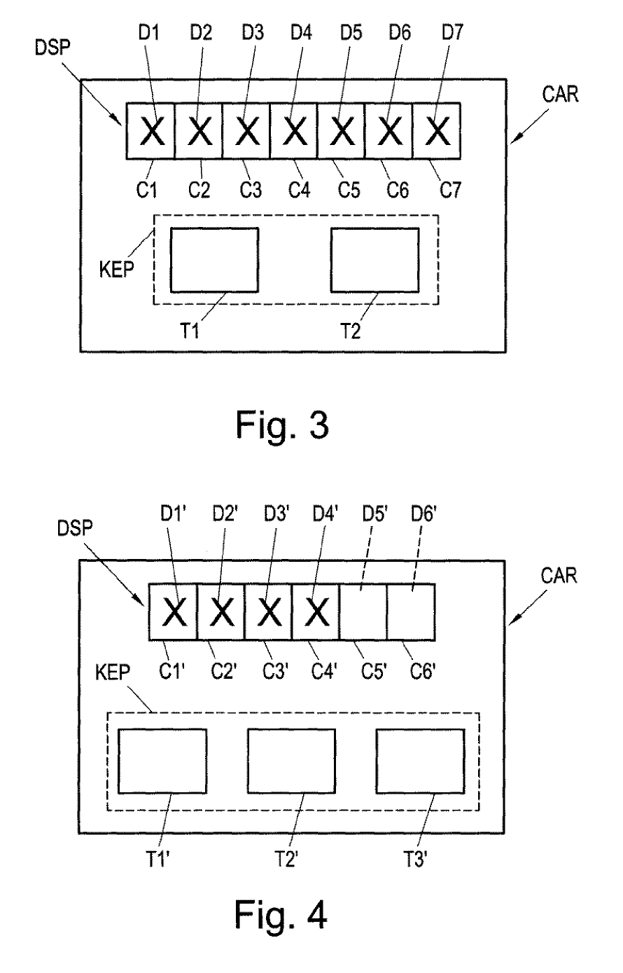

FIG. 3 shows a first embodiment of a card CAR for storing confidential information inf according to the invention. In this embodiment, the smart card CAR comprises a keypad KEP with two input elements T1, T2. The input elements T1, T2 are, for example, buttons to be pressed.

Each input element T1, T2 has a specific unambiguous value C1, C2. For example, pressing the first input element T1 means that a character such as an “A” is entered into the smart card CAR, and pressing the second input element T2 enters the character “B” into the smart card CAR. The PIN code which has to be entered into the smart card CAR then consists of a sequence of the characters “A” and “B”.

It will hereinafter be assumed that characters such as “A”, etc. are assigned to the input elements. However, input elements may also have a numerical value such as “1”, “2”, etc. It is only important that the input elements have different values.

The smart card CAR of FIG. 3 further comprises a display DSP on which the entered PIN code is displayed. In this preferred embodiment, the display DSP consists of several (seven) cells C1 to C7. In this example, each cell C1 to C7 is used to display one character D1 to D7 of the PIN code.

When the PIN code is entered by a user, an “X” is shown in the corresponding cell C1 to C7 of the display DSP. Thus, the PIN code is masked in the display DSP so that it cannot be spied upon, but the user obtains feedback information on how many characters D1 to D7 of the code have already been entered.

In principle, the PIN code may have any length. However, to obtain high security, it is preferred that the PIN code has a length of at least seven characters D1 to D7 in the case of two input elements T1, T2.

As mentioned above, it has been assumed in this example that the characters “A” and “B” are assigned to the first input element T1 and the second input element T2, respectively. Furthermore, it is assumed that the PIN code is “AABABBA”. After activation of the card, which may be done, for example, by pressing one or more of the input elements T1, T2, the correct PIN code is entered by pressing the input elements T1, T2 as follows: “first input element T1, first input element T1, second input element T2, first input element T1, second input element T2, second input element T2, first input element T1”.

After the PIN code has been entered successfully, the user is presented with the next item in the menu loop structure or directly with the confidential information inf. If the code is entered incorrectly, no access (to the subsequent entry) will be possible, or the confidential information will be annihilated after several trials.

FIG. 4 shows a further embodiment of a card CAR for storing confidential information inf according to the invention. In this embodiment, the smart card CAR comprises a keypad KEP with three input elements T1′, T2′, T3′. The input elements T1′, T2′, T3′ are, for example, buttons to be pressed.

Each input element T1′, T2′, T3′ has a specific unambiguous value C1′, C2′, C3′. For example, pressing the first input element T1′ means that a character such as an “A” is entered into the smart card CAR, pressing the second input element T2′ enters the character “B” into the smart card CAR, and pressing input element T3′ enters the character “C”. The PIN code which has to be entered into the smart card CAR then consists of a sequence of the characters “A”, “B” and “C”.

The smart card CAR of FIG. 4 further comprises a display DSP on which the entered PIN code is displayed. In this preferred embodiment, the display DSP consists of several (six) cells C1′ to C6′. In this example, each cell C1′ to C6′ is used to display one character D1′ to D7′ of the PIN code.

When the PIN code is entered by a user, an “X” is shown in the corresponding cell C1′ to C6′ of the display DSP. Thus, the PIN code is masked in the display DSP so that it cannot be spied upon, but the user obtains feedback information on how many characters D1′ to D6′ of the code have already been entered.

In the example shown in FIG. 4, a user has already entered the first four characters D1′ to D4′ of the PIN code, which are therefore masked with an “X”, while the fifth and the sixth character have not yet been entered.

In principle, the PIN code may have any length. However, to obtain high security, it is preferred that the PIN code has a length of at least five characters in the case of three input elements T1′, T2′, T3′. FIG. 4 shows an embodiment with more than five characters, namely, six characters, which increases the security of the PIN code.

As mentioned above, it has been assumed in this example that the characters “A”, “B” and “C” are assigned to the first, second and third input element T1′, T2′, T3′, respectively. Furthermore, it is assumed that the PIN code is “ACBABB”. After activation of the card, which may be done, for example, by pressing one or more of the input elements T1′, T2′, T3′, the correct PIN code is entered by pressing the input elements T1′, T2′, T3′ as follows: “first input element T1′, third input element T3′, second input element T2′, first input element T1′, second input element T2′, second input element T2′.

After the PIN code has been entered successfully, the user is presented with the next item in the menu loop structure or directly with the confidential information inf. If the code is entered incorrectly, no access (to the subsequent entry) will be possible.

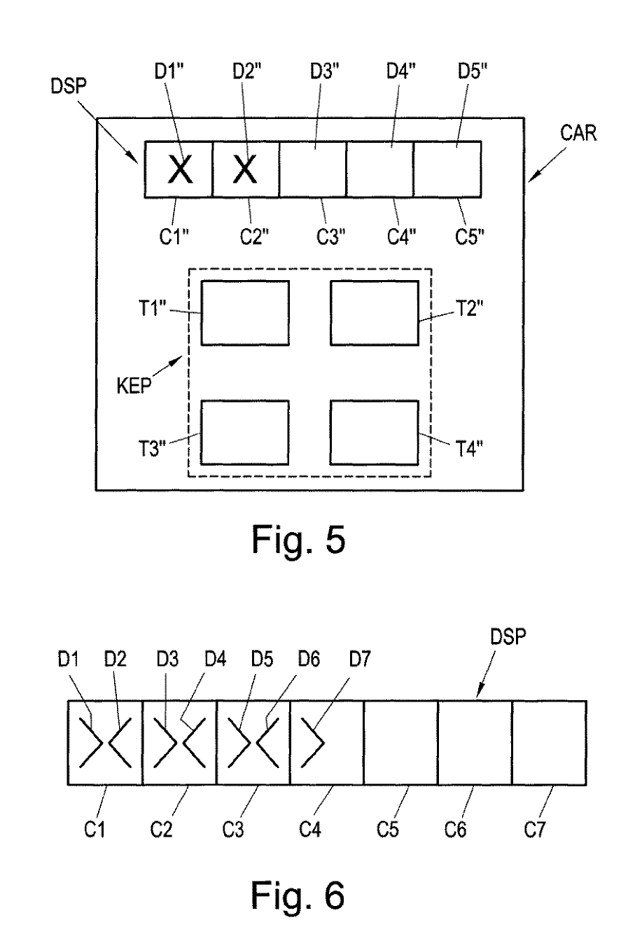

Furthermore, FIG. 5 shows an embodiment of a smart card CAR with a keypad KEP with four input elements T1″ to T4″ and a display DSP with five cells C1″ to C5″ for displaying five characters D1″ to D5″ of a PIN code.

The invention uses a combination of input elements in which the sequence of the input elements is used as the actual security code and not a selected number or letter. The security available is then N, wherein N is the number of input elements to the power of the number of characters in the PIN code. For example, in the case of two buttons and seven characters in the PIN code, there are 128 choices and a security level of 128.

Coding in a way as described above will considerably reduce the number of input elements to be pushed. Moreover, it removes the variation of number clicks needed between different codes. A code may then read, for example, BABBABAA or CBBACABBAC.

Refraining from a decimal code also allows a larger variation of security by varying the number of characters in the PIN code, while the risk of other people “scanning or overseeing” the code is also very low.

In the following table, the initially described “conventional” solution using two or three buttons (“scroll” in one direction plus “enter”; “scroll up” and “scroll down” plus “enter”) to navigate through the ten numbers 0 to 9 of a decimal PIN code is compared with that of this invention, which clearly shows that the new solution uses slightly more than half the average number of clicks than the conventional solution and less than the maximal number of clicks. It should be noted that a user having a “clumsy” PIN code will have to use the maximal number of clicks whenever he enters his PIN code. “Size PIN” in the table means the length of the PIN code, i.e. the number of characters in the PIN code.

| | Decimal | | | | This invention | | | |
|---|---|---|---|---|---|---|---|---|
| | Size | | Avg | Max | Size | | Avg | Max |
| | PIN | Security | clicks | clicks | PIN | Security | clicks | clicks |
| 2 input | 3 | 1000 | 15 | 30 | 7 | 128 | 7 | 7 |
| elements | | | | | | | | |
| | 4 | 10000 | 20 | 40 | 9 | 512 | 9 | 9 |
| | | | | | 13 | 8192 | 13 | 13 |
| | | | | | 14 | 16384 | 14 | 14 |
| 3 buttons | 3 | 1000 | 7.5 | 15 | 5 | 243 | 5 | 5 |
| | 4 | 10000 | 10 | 20 | 6 | 729 | 6 | 6 |
| | | | | | 7 | 2187 | 7 | 7 |
| | | | | | 8 | 6561 | 8 | 8 |
| | | | | | 9 | 19683 | 9 | 9 |

To increase the security of the PIN code using a display DSP with a number of cells, it is possible to use, for example, seven cells C1 to C7 as shown in FIG. 6. This display DSP uses one cell C1 to C7 to display two characters D1 to D7 of the PIN code (only seven characters are indicated in the Figure, which have already been entered, whereas the further seven characters have not yet been entered). Consequently, a feedback of fourteen characters of a PIN code can be indicated by showing “>” for the first character D1, D3, D5, D7 in the cell C1, C2, C3, C4, and adding “<” for the second character D2, D4, D6 (“>” and “<” together forming the X in the cells).

FIG. 6 shows a specific example of display DSP to be used for the invention. However, any other combination of parts of a display may also be used, for example, III.

Finally, FIG. 7 shows a reader REA for communication with a smart card CAR as described above. The reader REA and the smart card CAR may communicate with each other via a contact or in a contactless way. The smart card CAR comprises a keypad KEP with two, three, four or more input elements (max. nine) according to the invention and preferably a display DSP. In this advantageous embodiment, the reader REA also comprises a keypad KEP′ with a number of input elements corresponding to the number of input elements on the smart card CAR, which input elements have a specific unambiguous value. Furthermore, the reader REA′ comprises a display DSP′.

However, it should be noted that a reader as already known in the state of the art may also be used to communicate with and enter a PIN code into a smart card CAR according to the invention.

It should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. Use of the verb “comprise” and its conjugations does not exclude the presence of elements or steps other than those stated in any claim or the specification as a whole. The singular reference of an element does not exclude the plural reference of such elements and vice versa. The invention may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. A card (CAR) comprising input elements (T1, T2; T1′, T2′, T3′; T1″, T2″, T3″, T4″) for entering a PIN code into the card, wherein a specific unambiguous value is assigned to each input element (T1, T2; T1′, T2′, T3′; T1″, T2″, T3″, T4″), and wherein the card (CAR) comprises at least two and maximally nine of said input elements (T1, T2; T1′, T2′, T3′; T1″, T2″, T3″, T4″).

2. A card (CAR) as claimed in claim 1, wherein the number of input elements is limited to two.

3. A card (CAR) as claimed in claim 1, wherein the number of input elements is limited to three.

4. A card (CAR) as claimed in claim 1, wherein the number of input elements is limited to four.

5. A card (CAR) as claimed in any one of claims 1 to 4, wherein the PIN code consists of at least four characters (D1, D2, D3, D4, D5, D6, D7; D1′, D2′, D3′, D4′, D5′, D6′; D1″, D2″, D3″, D4″, D5″).

6. A card (CAR) as claimed in claims 2 and 5, wherein the PIN code consists of at least seven characters (D1, D2, D3, D4, D5, D6, D7).

7. A card (CAR) as claimed in claims 3 and 5, wherein the PIN code consists of at least five characters (D1′, D2′, D3′, D4′, D5′, D6′).

8. A card (CAR) as claimed in any one of claims 1 to 7, wherein the card (CAR) comprises a display (DSP) for displaying the entered PIN code.

9. A card (CAR) as claimed in claim 8, wherein the display (DSP) comprises at least one display cell (C1, C2, C3, C4, C5, C6, C7; C1′, C2′, C3′, C4′, C5′, C6′; C1″, C2″, C3″, C4″, C5″) for each character of the PIN code.

10. A card (CAR) as claimed in claim 9, wherein each display cell (C1, C2, C3, C4, C5, C6, C7; C1′, C2′, C3′, C4′, C5′, C6′; C1″, C2″, C3″, C4″, C5″) is capable of displaying two or more characters of a PIN code.

11. A method of entering a PIN code into a card (CAR), using input elements (T1, T2; T1′, T2′, T3′; T1″, T2″, T3″, T4″), wherein a specific unambiguous value is assigned to each input element (T1, T2; T1′, T2′, T3′; T1″, T2″, T3″, T4″), and wherein at least two and maximally nine of said input elements (T1, T2; T1′, T2′, T3′; T1″, T2″, T3″, T4″) are provided for entering the PIN code.

12. A method as claimed in claim 11, wherein the number of inputs elements is limited to two, three or four.

13. A method as claimed in claim 12, wherein the PIN code consists of at least four characters (D1, D2, D3, D4, D5, D6, D7; D1′, D2′, D3′, D4′, D5′, D6′; D1″, D2″, D3″, D4″, D5″).

14. A method as claimed in claim 13, wherein the PIN code consists of at least seven characters (D1, D2, D3, D4, D5, D6, D7) in the case of two input elements (T1, T2), and wherein the PIN code (PIN) consists of at least five characters (D1′, D2′, D3′, D4′, D5′, D6′) in the case of three input elements (T1′, T2′, T3′).

15. A method as claimed in any one of claims 11 to 14, wherein the entered PIN code is displayed on a display (DSP).

16. A method as claimed in claim 15, wherein the display (DSP) comprises at least one display cell (C1, C2, C3, C4, C5, C6, C7; C1′, C2′, C3′, C4′, C5′, C6′; C1″, C2″, C3″, C4″, C5″) for each character of the PIN code.

17. A method as claimed in claim 16, wherein each display cell (C1, C2, C3, C4, C5, C6, C7; C1′, C2′, C3′, C4′, C5′, C6′; C1″, C2″, C3″, C4″, C5″) is capable of displaying two or more characters of a PIN code.

18. A card reader (REA) for a card (CAR), the reader (REA) being capable of carrying out a method as claimed in any one of claims 11 to 17.
